(19) United States
(12) Patent Application Publication
(10) Pub. No.: US 2006/0037456 A1
(43) Pub. Date: Feb. 23, 2006

(54) Circular saw blade

(75) Inventor: Sylvain St-Hilaire, St-Romuald (CA)

Correspondence Address: HARRINGTON & SMITH, LLP, 4 RESEARCH DRIVE, SHELTON, CT, 06484-6212, US

(73) Assignee: Scies BGR Inc.

(21) Appl. No.: 10/923,055

(22) Filed: Aug. 19, 2004

(51) Int. Cl. B27B 33/02

(52) U.S. Cl. 83/848

(57) ABSTRACT

A circular gang edger blade comprises a plurality of teeth having a cutting angle and being arranged on the periphery of the blade so as to yield a pitch between two adjacent of the teeth between about 2.3 cm and about 3.2 cm; each pair of adjacent teeth defining a rounded gullet therebetween for receiving and removing sawdust. The teeth are configured and sized so that each gullet defines a sawdust-receiving area comprised between about 1.1 cm² and about 1.7 cm². Some of the gullets are provided with a recess defining an expansion joint extending in a direction defining a smaller angle than the cutting angle. Contrarily to gang edger blades from the prior art which are characterized by a sawing variation of at least 0.635 cm, it has been observed that a gang edger blade according to the present invention is characterized by sawing variation of no more than 0.25 cm.

### FIELD OF THE INVENTION

The present invention relates to circular saw blades including teeth along the periphery thereof. More specifically, the present invention is concerned with gang edger blades.

### BACKGROUND OF THE INVENTION

According to conventional rules for conceiving a gang edger blade, the optimal tooth bite is between about 0.85 mm (0.033 in) and 1.25 mm (0.05 in). The minimum bite size depends on the clearance of the tooth and the thickness of the blade. According to conventional teachings, the minimum tooth bite size should be at least 0.25 mm (0.01 in) greater than the clearance of the tooth to prevent the rising of the temperature at the periphery of the blade.

The size of the bite can be determined using the following equation:
(lumber feed speed×12)/(number of teeth×number of rotations per minute (RPM)),
while the clearance is determined as:
((width of a tooth)−(width of the plate of the blade))/2.

For example, for a carbide saw blade having a 48.26 cm (19 in) diameter, a thickness of 22.9 mm (0.9 in), 42 teeth having a kerf of about 0.32 mm (0.013 in), the size of the bite is about 1 mm (0.004 in), which is at least 0.25 mm (0.01 in) greater than the clearance, which is 0.44 mm (0.017 in), when the RPM is 2875 and the lumber feed speed is 2 m/s (78.74 in/s).

Also, according to gang edger blade conceiving rules from the prior art, 30 percent of the gullet area 5 (see FIG. 1) should be free of sawdust at any time.

The sawdust volume is determined by the following equation:
bite size of a tooth×depth of the sawing×2.5;
2.5 being the expansion factor of sawdust.

Using this equation, a sawdust volume of about 10 ml can be determined when considering the prior example.

The gullet area 5 can be determined as:
((pitch of the teeth)×(gullet depth))/1.75

Using data from the prior example, one can find a gullet area of about 4.5 cm² (0.7 sq in)

The above formulas have been used to conceive gang edger blades since the last thirty to thirty five years according to the prior art. However, both the operation parameters of gang edgers and their width have changed during that same period. For example, the lumber feeding speeds have increased up to five times, the RPM of the tools have doubled and the width of the gang edger blades are now about half what they use to be. Moreover, the saw mounting and guiding means have also evolved from being purely mechanical to include hydrostatic guiding means.

Because of the above-mentioned changes in the operating environment of gang edgers over the years, some drawbacks have been observed in the use of gang edger blades from the prior art.

Indeed, it has been found that conventional gang edger blades loose too much sawdust at the bottom of the gullet, which causes overheating at the periphery of the blade. This overheating decreases the efficiency of the sawing. A solution that has been proposed to minimize overheating of the blade is to stretch the metal fibers, which is a subjective and imprecise process. This process comprises the step of estimating the expansion of the heated steel at the periphery of the saw and to stretch the metal nearer to the center of the blade so as to try and compensate the stretching during operation of the saw.

Another drawback of gang edger blades conceived according to conventional processes is that the gullets have to be deeper and deeper to allow receiving the sawdust, considering the always increasing feeding speed of the lumbers to sawing, which causes washboarding on the sawn lumber as a consequences of the microbending of the weaken teeth.

### OBJECTS OF THE INVENTION

An object of the present invention is therefore to provide an improved circular saw blade.

Another object of the invention is to provide an improved gang edger blade.

### SUMMARY OF THE INVENTION

More specifically, in accordance with the present invention, there is provided a circular saw blade comprising:

a plurality of teeth having a cutting angle and being arranged on the periphery of the blade so as to yield a pitch between two adjacent of the plurality of teeth between about 2.3 cm (0.9 in) to about 3.2 cm (1.25 in); each pair of adjacent teeth of the plurality of teeth defining a rounded gullet therebetween for receiving and removing sawdust; some of the gullets extending deeper than the remaining gullets in a direction defining a smaller angle than the cutting angle; the some of the gullets extending deeper than the remaining gullets defining expansion joint.

A circular-saw blade according to the present invention is characterized with a smaller pitch than gang edger blades from the prior art which typically have a pitch of about 3.5 cm (1.38 in).

According to another aspect of the present invention, there is also provided a circular saw blade comprising:

a plurality of teeth having a cutting angle and being arranged on the periphery of the blade; each pair of adjacent teeth of the plurality of teeth defining a rounded gullet therebetween for receiving and removing sawdust; each the gullet defining a sawdust-receiving area comprised between about 1.1 cm² (0.17 sq in) and about 1.7 cm² (0.26 sq in); some of the gullets being provided with a recess defining an expansion joint extending in a direction defining a smaller angle than the cutting angle.

A gang edger blade according to the present invention includes more teeth than circular gang edger blade from the prior art having the same diameter. Providing more teeth than what conventional gang edger methods call for yields less stress on the blade and reduces the heat at the periphery of the blade. This improves the quality of the sawing surface. Moreover, it allows for the introducing of expansion joints in some gullets, which allow the periphery of the blade to expand form front to back instead of from left to right, contributing to improve the precision of the sawing.

Contrarily to gang edger blades from the prior art which are characterized by a sawing variation of at least 0.635 cm (0.25 in), it has been observed that a gang edger blade according to the present invention is characterized by sawing variation of no more than 0.25 cm (0.1 in).

Tests performed with a gang edger blade according to the present invention demonstrated that its use yields reduced downtime (less than 1 percent) compared to using a gang edger blade from the prior art (typically about 5%).

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1, which is labeled prior art, is an elevation of a peripheral portion of a circular saw blade, illustrating the gullet area;

FIG. 2 is an elevation of a circular saw blade according to a first illustrative embodiment of the present invention; and

FIG. 3 is an elevation of a circular saw blade according to a second illustrative embodiment of the present invention.

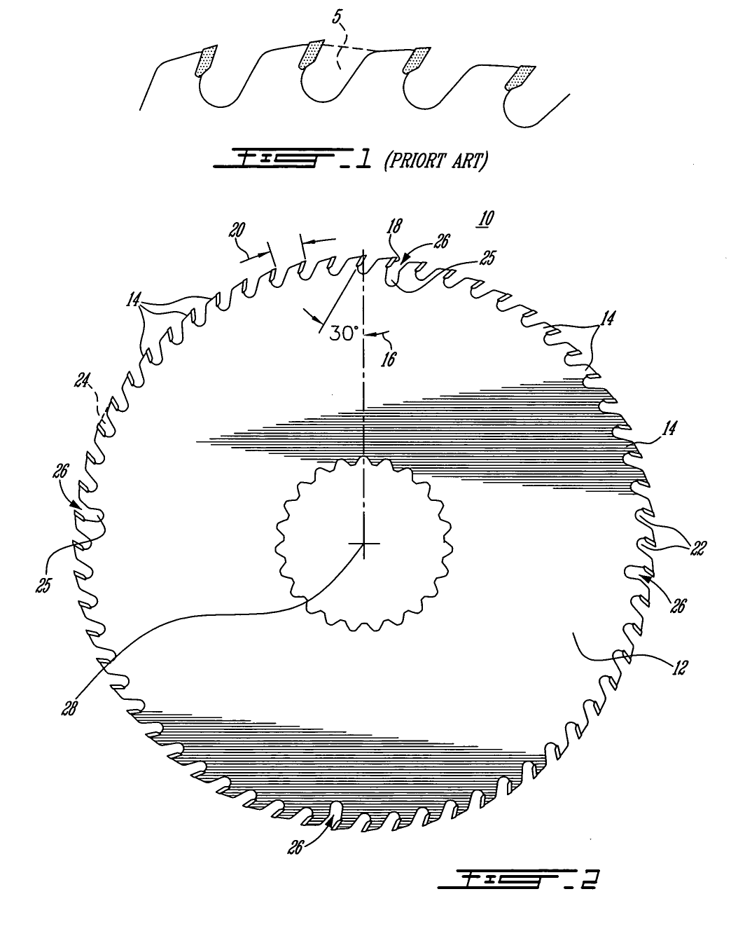

### DETAILED DESCRIPTION

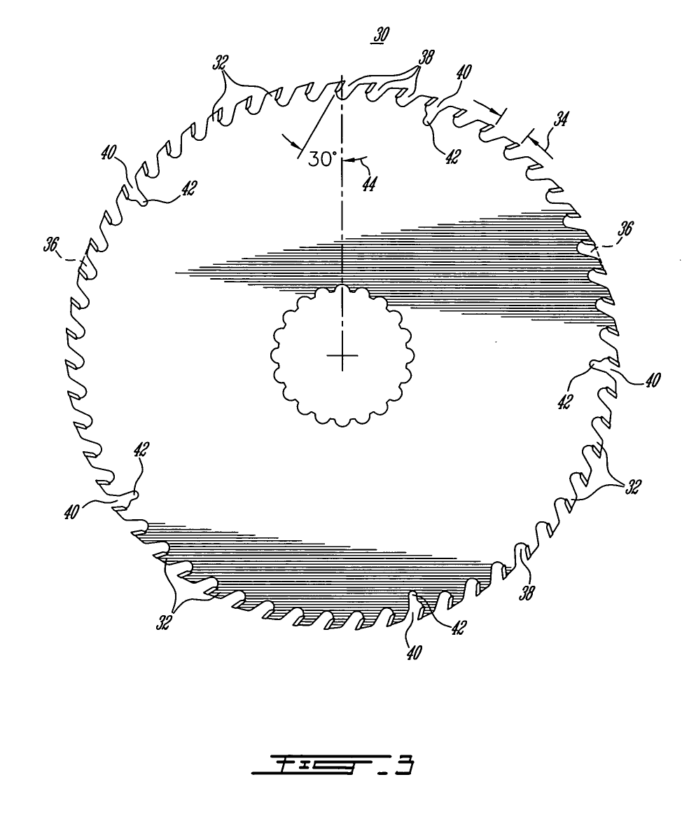

Turning now to FIG. 2 of the appended drawings, a gang edger blade 10 according to a first illustrative embodiment of the present invention will be described.

The rip saw blade 10 is in the form of a circular plate 12 having a diameter of 50.8 cm (20 in) and a plurality of teeth 14 arranged on the periphery of the plate 12. The teeth 14 are provided with a cutting angle 16 of 30° defined by the angle between the surface 18 of a tooth 14, which is perpendicular to the plane of the plate 12, and a radius intersecting the middle of that plane as it is conventionally known in the art. A blade according to the present invention may have another cutting angle 16 and general configuration of the teeth 14 without departing from the spirit and nature of the present invention.

More specifically, the blade 10 is provided with 60 (sixty) teeth yielding a pitch 20 of about 2.66 cm (1.05 in) considering the diameter of 50.8 cm (20 in) of the plate.

Each pair of adjacent teeth 14 defines a rounded gullet 22 therebetween. The gullets 22 aim at receiving and removing sawdust during operation of the saw blade 10 as it is well known.

The teeth 14 are so configured and sized as to yield a gullet area 24 of about 1.5 cm² (0.23 sq in).

Four of the gullets 22, represented by numeral reference 26, extend deeper than the remaining gullets 22, since they are provided with a gullet extension 25. The four deeper gullets 26 are symmetrically positioned around the periphery of the blade 12. Each of the gullet extension 25 is oriented towards the center 28 of the plate 12. The width of the extension 25 is the same as the width of the aperture of all the gullets 22.

The deeper gullets 26, and more specifically, the gullets extension 25, act as expansion joint allowing the blade 10 to expand on its periphery from front to back. This has been found to yield a more precise sawing than without gullet extension 25. It also allows to more precisely guide the blade 10 during operation of a gang edger (not shown) equipped with a conventional guiding system (not shown) along with such a blade 10.

Providing a gullet extension 25 in a direction defining a smaller angle than the cutting angle allows preventing, delaying or at least minimizing cracking of the blade in the gullets 14 and 26.

Even though the cracking is delayed, minimized or prevented in some cases when the angle of the gullets extension is smaller than the attack angle 16 of the teeth 14, it has been found that such effect is maximized when the angle of the gullet extension is zero. i.e. when the gullet 26 extends radially.

A gang edger blade 30 according to a second illustrative embodiment of the present invention will now be described with reference to FIG. 3.

Since the blade 30 is similar to blade 10, only the differences between the two will be described herein in more detail.

The diameter of the blade 30 is 48.3 cm (19 in) and it periphery is provided with 55 teeth 32, yielding a pitch 34 of about 2.75 cm (1.09 in).

The teeth 32 are so configured and sized as to yield a gullet area 36 of about 1.62 cm² (0.25 sq in).

Five of the gullets 38, represented by numeral reference 40, are provided with a gullet extension 42. The four deeper gullets 40 are symmetrically positioned around the periphery of the blade 12. The angle of the gullet extension 42 is smaller than the attack angle 44 of the teeth 32. The gullet extension 42 is narrower than the aperture of the gullets 38.

Even though a gang edger blade according to the present invention has been illustrated with reference to embodiments having four or five deeper gullets, their number may vary depending on the use of the saw blade.

It is to be noted that the number of teeth increases with the diameter of the blade while the linear velocity of the blade is inversely proportional to its diameter. Therefore, the pitch of the teeth of a blade according to the present invention remains between 2.28 cm (0.9 in) and 3.18 cm (1.25 in) for any blade diameter.

The gullet area of a blade according to the present invention may vary between about 1.1 cm² (0.17 sq in) and 1.7 cm² (0.26 sq in).

Although the present invention has been described hereinabove by way of preferred embodiments thereof, it can be modified without departing from the spirit and nature of the subject invention, as defined in the appended claims.

What is claimed is:

1. A circular saw blade comprising:
a plurality of teeth having a cutting angle and being arranged on the periphery of the blade so as to yield a pitch between two adjacent of said plurality of teeth between about 2.3 cm and about 3.2 cm; each pair of adjacent teeth of said plurality of teeth defining a rounded gullet therebetween for receiving and removing sawdust; some of said gullets extending deeper than the remaining gullets in a direction defining a smaller angle than the cutting angle; said some of said gullets extending deeper than the remaining gullets defining expansion joint.

2. A circular saw blade as recited in claim 1, wherein said circular saw blade is a gang edger blade.

3. A circular saw blade as recited in claim 1, wherein said gullets extending deeper than the remaining gullets being symmetrically positioned around the blade.

4. A circular saw blade as recited in claim 3, including between three (3) and seven (7) of said deeper gullets defining expansion joints.

5. A circular saw blade as recited in claim 1, wherein said some of said gullets extending deeper than the remaining gullets being oriented towards the center of the blade.

6. A circular saw blade as recited in claim 1, wherein said cutting angle is about 30 degrees.

7. A circular saw blade as recited in claim 1, having a diameter of about 48 cm and being provided with between 48 (forty-eight) and 66 (sixty-six) teeth.

8. A circular saw blade as recited in claim 1, having a diameter of about 51 cm and being provided with between 50 and 70 teeth.

9. A circular saw blade comprising:
a plurality of teeth having a cutting angle and being arranged on the periphery of the blade; each pair of adjacent teeth of said plurality of teeth defining a rounded gullet therebetween for receiving and removing sawdust; each said gullet defining a sawdust-receiving area comprised between about 1.1 cm² and about 1.7 cm²; some of said gullets being provided with a recess defining an expansion joint extending in a direction defining a smaller angle than the cutting angle.

10. A circular saw blade as recited in claim 9, wherein said circular saw blade is a gang edger blade.

11. A circular saw blade as recited in claim 9, wherein said recess and said gullet having substantially the same width.

12. A circular saw blade as recited in claim 9, wherein said gullets extending deeper than the remaining gullets being symmetrically positioned around the blade.

13. A circular saw blade as recited in claim 9, including between three (3) and seven (7) of said some of said gullets being provided with a recess.

14. A circular saw blade as recited in claim 9, wherein said recess being oriented towards the center of the blade.

15. A circular saw blade as recited in claim 9, wherein said recess has a width smaller than the width of said gullet.

16. A circular saw blade as recited in claim 9, wherein said cutting angle is about 30 degrees.

17. A circular saw blade as recited in claim 9, having a diameter of about 48 cm and being provided with between 48 (forty-eight) and 66 (sixty-six) teeth.

18. A circular saw blade as recited in claim 9, having a diameter of about 51 cm and being provided with between 50 and 70 teeth.
